(19) United States
(12) Patent Application Publication
(10) Pub. No.: US 2004/0031648 A1
(43) Pub. Date: Feb. 19, 2004

(54) Device unit for generating a reciprocating driving motion for driving movable machine elements

(76) Inventor: Alfred Rasmussen, Svendborg (DK)

Correspondence Address: NIXON PEABODY, LLP, 401 9TH STREET, NW, SUITE 900, WASINGTON, DC, 20004-2128, US

(21) Appl. No.: 10/450,168

(22) PCT Filed: Dec. 8, 2001
(86) PCT No.: PCT/DK01/00815

(30) Foreign Application Priority Data
Dec. 11, 2000 (DK) BA 2000 00369
Aug. 16, 2001 (DK) BA 2001 01225

(51) Int. Cl. F03G 1/00

(52) U.S. Cl. 185/11

(57) ABSTRACT

The present invention concerns a drive unit for generating a reciprocating driving motion for driving movable machine elements in relation to fixed surroundings. In connection with the invention, it is relevant to speak of oscillatory motion, and in connection herewith vibrators.

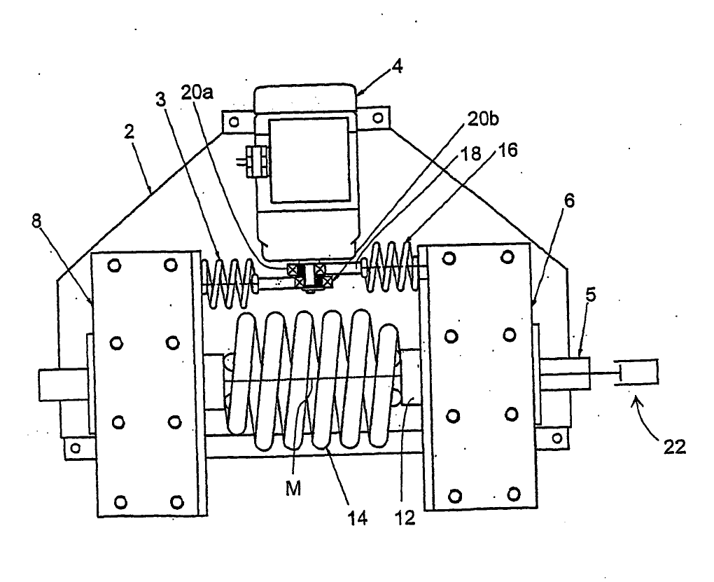

The invention is focused on the use of such resonance springs, and it is based on consideration of the fact that the effect of the these springs is also dependent on a reactive force, namely that the spring has a fixed, supported end part in relation to which the free end of the spring may move for performing the actual drive motion. By the invention it is realised that it is possible to minimise or to completely eliminate the reactive force on the fixed part by utilising an “opposed resonance system” which substitutes a fixed rear support of the active resonance spring and work in opposite phase to this with approximately corresponding resonance characteristic.

The total device will depend on working with a co-ordinated opposed phase activation of the two systems, which is, however, easily achieved, e.g. by using an interposed vibrator or a driven rotating eccentric which via interposed connecting drive springs may transmit oppositely directed drive forces to the oscillating mass bodies.

### BACKGROUND OF THE INVENTION

1. Field of the Invention

The present invention concerns a drive unit comprising a at least one motor, which motor is connected to at least one first spring, which first spring is connected to at least one movable mass, which movable mass is connected to at least one second spring.

2. Description of Related Art

The present invention also concerns also a method for generating reciprocating drive motion for driving movable elements relative to fixed surroundings by using a spring and at least one moveable mass forming a resonance oscillating system, where the oscillating system is adapted to driving means.

A drive unit for generating a reciprocating driving motion can be used for driving movable machine elements in relation to fixed surroundings. This situation occurs in quite many connections, e.g. by driving rapidly working piston pads or sundry hammering or punching devices, and there are many prior art systems for transforming e.g. motion of a turning shaft to a relevant reciprocating motion. Only it is a condition that the shaft is guided or supported in such a way so that it effectively can resist the reactive force by which it is actuated itself by the machine part which it is working to move.

In connection with the invention, it is relevant to speak of oscillatory motion, and in connection with vibrators it is prior art to make use of resonance springs with may increase the efficiency of the drive unit considerably with suitable adaptation with regard to frequency and moved mass. The invention is focused on the use of such resonance springs, and it is based on consideration of the fact that the effect of the these springs is also dependent on a reactive force, namely that the spring has a fixed, supported end part in relation to which the free end of the spring may move for performing the actual drive motion. At the supported end part of the spring there will hereby occur a corresponding large oscillating action, and while this may be acceptable by devices of small dimensions, it has appeared that in connection with larger and heavier devices with appreciable stroke, considerable vibrations occur at the supported end of the springs, so that fatigue easily arises in the material of the supporting part.

### SUMMARY OF THE INVENTION

The scope of the invention is to minimise or to completely eliminate forces acting at a support by using an oscillating system.

This can be achieved by a drive as described in the firs paragraph if modified in that the motor is connected to at least 2 opposed reciprocating springs which springs are connected to opposed reciprocating movable masses, which masses are connected to at least one second spring, where at least one of the oscillating mass bodies is provided with a linear guide system.

This can also be achieved by a method as described in the second paragraph if modified in that the drive movement is generated using a first spring as part of a resonance system formed by opposed reciprocating moving masses and a second spring interacting between the opposed reciprocating masses, where at least one of the oscillating mass bodies is guided in movement by a linear guide system.

By the drive and the method as described is utilised an “opposed resonance system” which substitutes a fixed rear support of the active resonance spring and work in opposite phase to this with approximately corresponding resonance characteristic. Basically, the case may be that to the rear end of the active spring there is coupled a corresponding spring which at its free rear end is coupled to a mass body with approximately the same mass as the one coupled to the front end of the active spring, and here it is advantageous that “heavy” mass bodies are used for creating good inertia in their oscillating motions, namely such inertia which by itself will be sufficient to effect the needed work at the working end of the active resonance system. When this system is backed up by an opposed, corresponding system which with suitable drive means is actuated for opposed phase oscillation, it implies that the rear end of the active spring will be held somehow at rest without any need for any other or fixed rear support and thereby without generating vibrations weakening the material. Possibly, fixation of the meeting point between the two systems may be used with the intention of establishing the working area of the active system, but at this point the vibrations occurring in relation to the surrounding may be so strongly attenuated that they do not cause any further problems. The total device will depend on working with a co-ordinated opposed phase activation of the two systems, which is, however, easily achieved, e.g. by using an interposed vibrator or a driven rotating eccentric which via interposed connecting drive springs may transmit oppositely directed drive forces to the oscillating mass bodies.

It is possible that both resonance systems are using one and the same through-going spring whereby it may just be observed that an intermediate part of the spring is almost stationary. In that case, the two opposed mass loads may be about the same size.

An alternative is that different mass bodies or oscillating masses and respective drive springs adapted thereto are used, whereby the resonance amplitudes very well may be different but, however, still act to strongly attenuate the resulting oscillation of the unit as a whole.

In connection with a system according to the invention, a plurality of particular circumstances or service conditions may occur, which here only are to be described briefly from an elementary example illustrated on the drawing which is a schematic view of a system according to the invention.

The device shown on the drawing comprises a base plate 2 carrying an electric motor 4 and linear horizontal guides 5 for a pair of mass bodies 6 and 8, which are each shown provided with an internal central pin 12. Between the pins 12 a helical spring 14 is held in position.

Each of the mass bodies 6 and 8 is connected with a lesser helical spring 3, 16 which at its other end, via a rod 18, is connected to a eccentric drive 20a, 20b, respectively, on the shaft of the motor 4 in such a way that these two drives hold and move respective rods 18 with mutual phase displacement of 180°.

In a basic set-up, the mass bodies have the same mass, e.g. with a weight of 5 kg, and the spring 14 is thus dimensioned so as to form a resonance system together with the bodies 6 and 8 coupled in opposed phase with a desired resonance frequency, e.g. 1200 rpm and 20 Hz. The motor 4 should hereby, preferably by frequency control, be adapted to drive the drive systems 16, 18 with a slightly lower or slightly higher frequency, e.g. 1155 or 1245 rpm. It is not desirable to drive the resonance system at the resonance frequency itself as the system thereby goes into extreme oscillations which very quickly may cause damage to the components, particularly the main spring 14. It is to be noted that also in ordinary single resonance systems it is prior art to make distance to the resonance frequency itself, and there is indication that by the invention one may work with reduced distance to the resonance frequency and thereby achieve an increased utilisation of power in the system.

In the symmetrical basic set-up in question, it may be clearly be seen that the system, by starting the motor 4, goes into opposed phase oscillation when the motor shaft reaches a rotational speed in the so-called resonance zone around the resonance frequency itself. The oscillating system 6, 8, 14 is restrained only by the resilient drive connection to the motor shaft in the axial direction through the small springs 16, but this is sufficient for holding the oscillating system in such a way that the centre point of the large spring 14 is standing completely still under the motor shaft while strong oscillations are occurring at both sides thereof.

In order to absorb a small unbalance in the system, one may alternatively mount the drive unit 4, e.g. an electric motor, on a guide 5 which very well may be of the same kind used here for guiding the mass bodies 6, 8. This way of mounting the drive unit furthermore implies the advantage that the foundation for the whole system may form a part of the oscillating mass.

In order to initiate the desired resonance oscillations it is not a primary condition that both sides of the opposed phase system are actuated separately; if only one side is actuated, an opposed phase oscillation will automatically be generated in the resonance zone by the other side of the system via the spring 14 as any resonance system will react to almost any kind of actuation at or near the resonance frequency. Even here it may thus be questioned whether one or the other of the drive connections 16, 18 really may be done without, something which may depend on deeper examination of the efficiency of the system in cases where the system may be utilised in practice for performing work at one or at both sides.

In the drawing it is shown in principle that the right mass body may be in working connection with a force exerting element 22 which may be any relevant kind for utilising the generated oscillatory energy, e.g. a pump piston or a pressure plate for crushing shells of nuts. In practice, there will be a very large number of relevant applications which do not need to be described in detail here.

It is, of course, to be taken into account that the added working element 22 entirely or partly is forming part of the oscillating mass and that the work power to be transmitted, including a possibly occurring friction, will attenuate the oscillation amplitude. A certain, or even considerable, mass unbalance in the system is not decisive for the functioning as the system by itself goes into opposed phase oscillation, only with a displaced resting point of the spring 14 and with different amplitude at the two sides. However, it is counted on that the most effective exertion of force may take place in an approximately symmetrical system, which may be the reason for loading both sides of the system with uniform loads.

It is to be emphasised that it is not significant for the drive unit according to the invention by which means the oscillations of the system are generated and supported if only the force transmission occurs with a low degree of loss. Within the vibration technique, electromagnetic driving devices are used to a wide extent which, however, with the associated air gap result in tangible losses by heat formation. An ordinary electric motor 4 also yields such losses but, however, only of reduced size for a given power output.

Thus, possibly there may coupled a linear vibrator on only one of the mass bodies 6, 8 while the said axial connection of the system may be substituted by a weak spring between one end or both ends of the system and a fixed support part opposite thereto. The driving actuation is, however, not necessarily to occur with the same stroke as that which the mass body is moved with. With an electromagnetic drive, a linear unit, possibly with drive directly on the mass bodies, may be used.

Besides, the supplied energy is not necessarily to be supplied directly to one or both mass bodies if only the energy affects the system as a whole, i.e. the energy may quite as well be transmitted to a winding section of the spring system 14 outside its resting point. When this resting point is well defined, it may be clamped for full takeover of the axial connection of the system, and hereby it will even be a possibility that such a clamping may be performed while using a driven rocker body which in the resting area of the spring may actuate the clamped winding section for performing the rocking that this otherwise stationary winding section will do in connection with the expansion and contraction of the spring under the actual opposed phase oscillations; under certain conditions, such an oscillatory actuation with very little amplitude may be sufficient to induce strong resonance oscillations of the whole primary system.

The main spring system 14 is not necessarily to consist of one or more springs of the helical spring type, as in principle all kinds of spring systems may be considered, including curved springs, disk springs, gas springs, cantilever springs and elastomere spring masses. In practice, the mass bodies may have weights from quite low ones up to several tonnes, depending on the applications considered, of course with correspondingly adapted dimensioning of the spring system 14, irrespectively of the further arrangement of the latter. The system is not bound to any orientation in space and not to the use of a fixed guide either. Also, a guide may be arranged externally, e.g. integrated with the working unit 22.

What is claimed is:

1. A drive unit comprising at least one motor (4), which motor is connected to at least one first spring (3, 16), which first spring (3, 16) is connected to at least one movable mass (6, 8) which movable mass (6, 8) is connected to at least one second spring (14) characterized in that the motor (4) is connected to at least 2 opposed reciprocating springs (3, 16) which springs (3, 16) are connected to opposed reciprocating movable masses (6, 8), which masses (6, 8) are connected to at least one second spring (14) where at least one of the oscillating mass bodies (6, 8) is provided with a linear guide system (5).

2. A drive unit according to claim 1, characterised in that the motor (4) is connected to at least one first spring via a driven rotating eccentric (20a, 20b), which eccentric via at least one first spring (3, 16) transmit forces to at least one oscillating mass (6, 8).

3. A drive unit according to claim 1 or 2, characterised in that the rotating eccentric (20a, 20b) comprises means for oppositely drive the first springs (3, 6), which first springs (3, 6) drives the oscillating mass bodies (6, 8) in opposite phase.

4. A drive unit according to any of claims 1-3, characterised in that both masses (6, 8) are connected to at least one through-going resonance spring (14).

5. A drive unit according to any of claims 1-4, characterised in that the two oppositely directed masses (6, 8) are approximately of the same size.

6. A drive unit according to any of claims 1-4, characterised in that different mass bodies (6, 8) and at least one spring (14) adapted thereto, respectively, are used.

7. A drive unit according to any of claims 1-6, characterised in that a non moving point of the spring (14) is fixed by connecting to a fixed point.

8. A drive unit according to any of claim 1-7, characterised in that each of the mass bodies (6, 8) are connected by at least one spring (3, 16) which at its other end, preferably via a rod (18), is connected to at least one eccentric drive (20a, 20b) on a motor shaft, where the eccentric drive (20a, 20b) holds and moves respective rods (18) with mutual phase displacement in the interval between 0° and 360° and preferably with a phase displacement of 180°.

9. A drive unit according to any of claims 1-8, characterised in that the masses (6, 8) and the spring (14) forms a resonance system (6, 8, 16), which resonance system is driven by frequency control to oscillate with a slightly lower or slightly higher frequency than the resonance frequency.

10. A drive unit according to any of claims 1-9, characterised in that at least one mass body (6), preferably two mass bodies (6, 8), are in working connection with at least one force exerting element (22).

11. A drive unit according to any of claims 1-10, characterised in that the resonance spring system (14) consists of one or more springs (14) of the type helical springs, curved springs, disk springs, gas springs, cantilever springs, elastomere spring masses, or combinations of these kinds of springs.

12. A drive unit according to any of claims 1-11, characterised in that the linear guide system (5) is integrated with the force exerting element (22).

13. A drive unit according to any of claims 1-12, characterised in that at least one of the oscillating mass bodies (6, 8) is mounted on an elastic column.

14. A drive unit according to any of claims 1-13, characterised in that the drive unit comprises a plurality of sets of resonance spring systems (3, 6, 8, 14, 16), where these systems are disposed symmetrically around a driven eccentric.

15. A drive unit according to any of claims 1-14, characterised in that the energy source, e.g. an electric motor (4), is mounted on a guide preferably of the same kind used for guiding the mass bodies (6, 8), and whereby a foundation of the entire system forms part of the oscillating mass.

16. Method for generating reciprocating drive motion for driving movable elements relative to fixed surroundings by using a springs (14) and at least one moveable mass (6, 8) forming a resonance oscillating system (6, 8, 14), where the oscillating system (6, 8, 14) is adapted to driving means (4), characterised in that the drive movement is generated using a first spring (3, 16) as part of a resonance system formed by opposed reciprocating moving masses (6, 8) and a second spring (14) interacting between the opposed reciprocating masses (6, 8), where at least one of the oscillating mass bodies (6, 8) is guided in movement by a linear guide system (5).

17. Method according to claim 16, characterised in that the drive motion originates in energy supplied to a resonance spring system (6, 8, 14) where the said supplying of energy occurs outside the resting point of the resonance spring system (6, 8, 14).

18. Method according to claim 16, characterised in that the drive motion originates in energy supplied to a resonance spring system (6, 8, 14) where the said supplying of energy occurs at the resting point of the resonance spring system (6, 8, 14).

19. Method according to any of claims 16-18, characterised in that the drive motion originates in a system where the co-ordinated opposite phase activation of the two systems is achieved by using an interposed vibrator or a driven rotating eccentric (20a, 20b) which via interposed drive springs (3, 16) transmits oppositely directed forces to oscillating mass bodies (6, 8).

20. Method according to any of claims 16-19, characterised in that at least one resonance systems (6, 8, 14) are using one and the same through-going resonance spring (14).

21. Method according to any of claim 16-20, characterised in that the resonance systems are using at least one and preferably more through-going resonance springs (14).

22. A drive unit according to any of claims 16-20, characterised in that the two oppositely directed mass bodies (6, 8) are approximately of the same size.

23. Method according to any of claims 16-22, characterised in that the meeting point between the two resonance systems is fixed by connecting the resonance spring structure (14) to a fixed point.

24. Method according to any of claims 16-23, characterised in that the resonance system (6, 8, 16) is adapted, preferably by frequency control, to be driven with a slightly lower or slightly higher frequency than the resonance frequency.
